(19) United States
(12) Patent Application Publication
(10) Pub. No.: US 2013/0169000 A1
(43) Pub. Date: Jul. 4, 2013

(54) CRASH BAR AERODYNAMIC DEVICE

(71) Applicants: James Reiman, Winnetka, IL (US); Peter Heppel, Port-Louis (FR)

(72) Inventors: James Reiman, Winnetka, IL (US); Peter Heppel, Port-Louis (FR)

(73) Assignee: AEROFFICIENT LLC, Winnetka, IL (US)

(21) Appl. No.: 13/339,200

(22) Filed: Dec. 28, 2011

(51) Int. Cl. B62D 35/02

(52) U.S. Cl. 296/180.4

(57) ABSTRACT

An aerodynamic device for the crash bar of a tractor trailer and support structures is easily installed on the front and optionally on the rear of the crash bar forming a rounded fairing surface or “bull nose.” A device may optionally be attached to the crash bar support structures. Using a flexible material, such as EPDM extrusion, or forming a molded part in polyurethane elastomer, ensures that the fairing surface recovers its shape after being crushed so that the device may be used repeatedly with a retaining device at a docking bay during loading and unloading, for example.

### BACKGROUND OF THE INVENTION

1. Field of the Invention

This invention relates to a system for improving the aerodynamic profile of a tractor-trailer combination (referred to as a “truck”) using an aerodynamic device attached to the crash bar and/or related support structures of the trailer. The system improves fuel consumption without adversely impacting operation or service procedures in the loading dock, for example.

2. Description of Related Art

The amount of power needed to move a vehicle over land or through the air increases with the speed of the vehicle due to aerodynamic drag. The amount of power necessary to overcome aerodynamic drag directly translates into increased fuel consumption, and thus increased emission of greenhouse gases and pollutants, and increased cost of operation.

A variety of innovations aimed at reducing the aerodynamic drag of various transport vehicles, including tractor-trailer combinations, have been introduced in the prior art. These include efforts to make the hood, windscreen, fenders, etc. more streamlined in form, as well as by adding fairings to the cab roof, and in some cases, to the trailer.

U.S. Pat. No. 6,799,791 discloses a vehicle fairing structure that may be deployed on the rear of a trailer to reduce drag at the rear end of the trailer box. A front fairing structure for reducing drag created at the front of the trailer is disclosed in U.S. Pat. No. 7,604,284. A system that includes side fairings to further reduce drag is disclosed in U.S. Pat. No. 7,404,592. The disclosures of the aforesaid U.S. Pat. Nos. 6,799,791, 7,604,284 and 7,404,592 are incorporated herein by reference.

There are also aerodynamic structures disclosed in the prior art in which a fairing surface is attached to the underside of a trailer to ameliorate drag created by the trailer's wheel and tire assemblies, but such systems are relatively bulky and attachment to the trailer is not an optimal arrangement.

The invention disclosed herein further optimizes the aerodynamic profile of a truck by incorporating a fairing structure on the front face and optionally rear of the crash bar to reduce drag. The fairing structure is attached directly to the crash bar and optionally to its support structures, and does not interfere with the operation of the truck during unloading and loading, when, for example, a retaining device is positioned against the crash bar to retain the trailer at the loading bay.

### SUMMARY OF THE INVENTION

The inventors have investigated fairing structures to reduce the aerodynamic drag created by the crash bar of a trailer and its associated support structure which can be attached to the truck in the area of the crash bar to reduce aerodynamic drag. A further advantage of the aerodynamic device according to the invention is that it permits a docking restraint system to be positioned against the front of the crash bar, so that the trailer can be retained at the docking bay when the trailer is loading and unloading without requiring removal of the aerodynamic device and without affecting performance.

These and other objects of the invention are achieved in a simple manner with the aerodynamic device according to the invention which comprises, in one aspect, a flexible elastomeric material having opposite ends thereof adapted for attachment to the crash bar of a trailer and its support structure (collectively, the “crash bar”), and forming a rounded fairing surface when attached to the crash bar. The rounded fairing surface recovers its shape after being temporarily crushed. The flexible material may consist of a single sheet or be comprised of a plurality of sheets connected so as to form a sheet.

In another aspect, an aerodynamic device according to the invention comprises a molded part having a rounded front fairing surface and a flat rear surface adapted for attachment to the front surface of a crash bar of a trailer, said flat rear surface of the molded part being substantially coextensive with the front surface of the crash bar, and being formed of a material that recovers its shape after being temporarily crushed. A molded part may comprise multiple pieces which are assembled to form an integral part.

“Molded,” in this context, includes extruded parts, or parts fabricated by any means typically used to make plastic parts.

Optionally, a molded part or flexible sheet as described above is provided for attachment to the crash bar to form a fairing surface on the rear surface of the crash bar. Such rear fairing surface may have a different shape than the fairing surface on the front of the crash bar. In specific embodiments, the fairing surface behind the crash bar tapers to a rear-facing point, rather than a rounded shape, and may be longer, on the order of 12-15 inches, somewhat like the rear of an aircraft wing.

The invention may also be embodied in a kit for improving the aerodynamic performance of a truck, comprising: a resilient sheet approximately the width of a trailer crash bar having opposed ends and opposed lateral sides, the sheet having holes proximate the opposed ends thereof and having two cutouts on one of the opposed ends, each cutout being sized to accommodate a strut supporting the crash bar. Fasteners are provided with the kit fitting in the holes and adapted to fasten the opposed ends of the sheet to the top and bottom sides of the crash bar. The sheet has a length sufficient to form a rounded fairing surface when the opposed ends of the sheet are attached to the top and bottom sides of the crash bar.

Similarly, a kit may be provided with a molded part having a flat surface, and fasteners adapted to attach the flat surface of the molded part to a surface of the crash bar. A fairing surface extends from the flat surface attached to the crash bar, which may be integral with the flat surface of the molded part, or a separate piece configured to attach to the flat surface. In embodiments, the fairing surface is configured to hide the fasteners.

### BRIEF DESCRIPTION OF THE DRAWINGS

FIG. 1 is a schematic side view of a trailer crash bar with the aerodynamic device according to a first embodiment of the invention attached thereto.

FIG. 2 is a schematic side view of a trailer crash bar and the aerodynamic device according to a second embodiment of the invention.

FIG. 3 is a plan view of a sheet of resilient material according to one embodiment of the invention, prior to installation on the crash bar.

FIG. 4 is a detail of another embodiment of the invention, showing another mode of attaching the aerodynamic device to the crash bar.

### DETAILED DESCRIPTION OF THE PREFERRED EMBODIMENTS

Directions and dimensions used herein are stated with respect to the orientation of a tractor-trailer in normal use, so that “front” is the forward moving direction of the truck, “downward” and “bottom” are in the direction of the road surface, and “width” is the dimension from side to side of the truck, and so on.

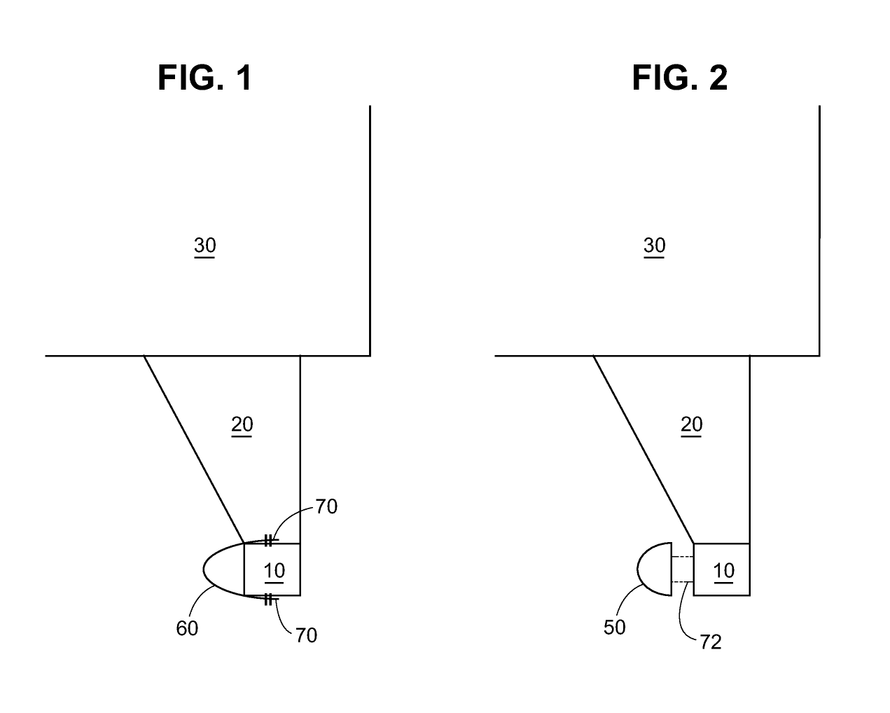

As is widely known, a “crash bar” is a horizontal structure supported from the rear of a trailer which is designed to improve safety in the event of a crash between the truck and a smaller vehicle. FIG. 1 depicts a side elevation view of a crash bar 10, which is supported by struts 20 extending from the trailer 30. Generally, a crash bar has an approximately square side profile with dimensions of about 4 inches on a side, although other configurations are known.

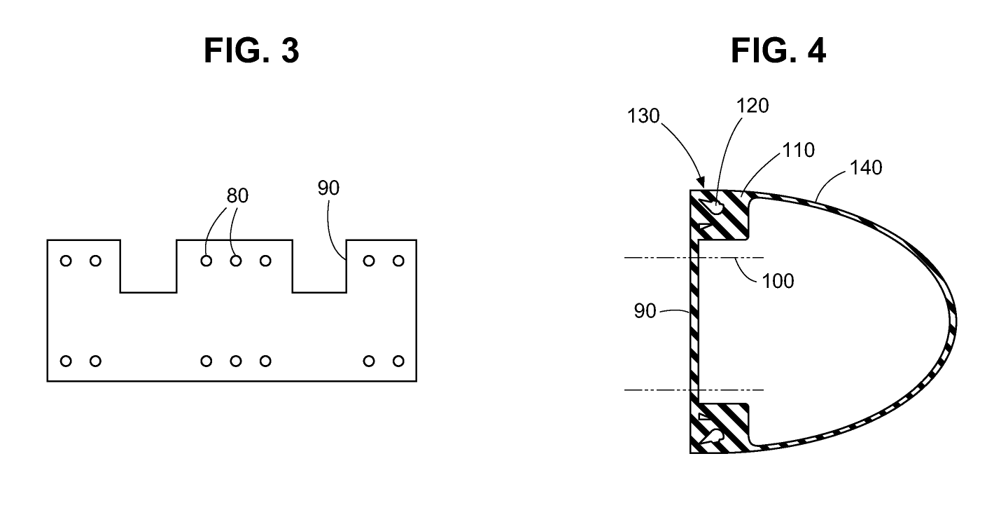

A bull nose on the front of the crash bar may be formed by providing a single sheet of resilient material 60 that is fastened to the top and bottom of the crash bar with screws, rivets or other equivalent fastening means 70. The person of ordinary skill in the art may also provide attachment of the flexible sheet to surfaces of the crash bar other than the top and bottom surfaces. As depicted in FIG. 3, the sheet of resilient material 60 may be provided with pre-fabricated holes 80 to allow attachment to the crash bar via the fastening means 70. In embodiments, a fold may be provided in the resilient sheet to hide the fastening means. The sheet of resilient material may be provided with cut-outs 90 adapted for positioning around support struts 20 attaching the crash bar to the trailer. Optionally, the same shape may be created on the rear of the crash bar via the same means.

An important aspect of the instant invention is that the fairing structure be comprised of a material that may be crushed, and when crushed is sufficiently resilient to return to its original shape without damage. During normal loading and unloading, the rear of the trailer is often backed up to a loading bay, which may result in the trailer's crash bar being pressed flush against the loading bay. A retaining device is typically used to retain the trailer against the loading bay. The “crushable” feature of the instant invention permits the back plane of the crash bar to be positioned so that the crash bar can abut the side of a loading bay and recover its shape after use, even after the retaining device is pressed against it. Likewise, when the retainer deforms the aerodynamic device on the front of the crash bar during loading or unloading, the device is capable of recovering its shape. The same material may also be similarly mounted on the forward and rearward edges of the crash bar's support structures.

From initial investigations, suitable resilient materials for use with the invention include extruded EPDM rubber. In the acronym EPDM, E refers to ethylene, P to propylene, D to diene and M refers to its classification in ASTM standard D-1418. Extruded EPDM provides a sturdy fairing surface, and at the same time recovers its shape well after bending. Other materials are contemplated for use as a resilient sheet including, without limitation, thermoplastic olefin (TPO) plastic, or polypropylene sheet.

FIG. 2 depicts a second embodiment of the invention, wherein the fairing structure is in the form of a molded part 50. The molded part may be provided with a flat rear surface that is substantially co-extensive with the crash bar front surface. Holes may be provided in the flat rear surface to allow for attachment of the part to the front surface of the crash bar, and also to hide the fasteners from view. For example, fasteners such as screws, rivets, or the like, may be hidden from view within the molded part. Alternatively, flaps may be provided on the molded part to facilitate attachment to the crash bar. In embodiments, the device does not extend in the rearward direction beyond the plane of the rear surface of the crash bar. However, a device employed on the rear surface of the crash bar may be sufficiently resilient so that it deforms when the crash bar is positioned against the loading bay and recovers its shape afterward.

FIG. 4 shows an embodiment of the invention wherein the aerodynamic device is comprised of a substantially flat sheet material 90, which may be SMC sheet material for example. The sheet material 90 is provided with mounting flanges 110. An extruded EPDM part 140 has receiving grooves which cooperate with the flanges to secure the EPDM part 140 to the flat sheet material 90. A gasket seal 130 is provided to insure the integrity of the part during use. The fasteners, which are provided along dotted lines 100, may be hidden from view in this manner.

The specific material used is not critical, although it is preferred that the molded part retains its fairing shape when the truck is moving and can recover its shape after being deformed by a retaining device in a docking bay. Initial investigations suggest that polyurethane elastomer is another good selection for making a molded part of this type.

Either the flexible sheet or the molded part may be provided as part of a kit, so that the sheet or part are provided with holes and the kit includes fasteners for installing the aerodynamic device to the crash bar, or to the support structures.

The foregoing description is not to be deemed as limiting the claimed invention, which is defined by the following claims.

What is claimed is:

1. An aerodynamic device for attachment to a crash bar of a tractor-trailer, comprising: a flexible elastomeric material, said material having opposed ends adapted for attachment to the crash bar of the trailer, and forming a rounded fairing surface when attached to the crash bar, the elastomeric material being selected so that the fairing surface recovers its shape after being temporarily crushed.

2. The aerodynamic device of claim 1, further comprising cut-outs adapted for positioning around support struts attaching the crash bar to the trailer.

3. The aerodynamic device of claim 1, wherein the elastomeric material is extruded EPDM.

4. The aerodynamic device of claim 1, wherein the device does not extend beyond the rear surface of the crash bar.

5. The aerodynamic device of claim 1, further comprising one or more additional pieces of elastomeric material forming a fairing surface in the rear-facing direction, and being resilient so that the fairing surface in the rear-facing direction recovers its shape after being temporarily crushed.

6. The aerodynamic device of claim 1, further comprising one or more additional pieces which form fairing structures when attached to the edges of the support structures of the crash bar.

7. The aerodynamic device of claim 1, wherein the material comprises one or more flexible sheets.

8. The aerodynamic device of claim 1, wherein the material comprises a plurality of connected sheets or pieces of material.

9. The aerodynamic device of claim 1, said material being adapted for attachment to the top and bottom surface of the crash bar.

10. The aerodynamic device of claim 1, wherein the flexible material has a width approximately equal to the width of the crash bar.

11. An aerodynamic device for the crash bar of a tractor trailer comprising, a molded part having a rounded front fairing surface and a flat rear surface adapted for attachment to the front and/or rear surface of a crash bar of a trailer, said fairing surface having substantially the same width as the crash bar and being formed of a material that recovers its shape after being temporarily crushed.

12. The aerodynamic device of claim 10, comprising holes provided in the rear surface for attachment of the device to the crash bar via fasteners which are hidden from view during use.

13. The aerodynamic device of claim 10, comprising attachment flaps extending from the molded part with holes provided for attachment to a top, bottom or rear surface of the crash bar.

14. The aerodynamic device of claim 10, wherein the molded part is formed of a polyurethane elastomer.

15. The aerodynamic device of claim 10, comprising a first sheet section and a second curved section which are joined to form an integral part.

16. A kit for improving the aerodynamic performance of a truck, comprising:
a resilient sheet approximately the width of a trailer crash bar having opposed ends and opposed lateral sides,
the sheet having holes proximate the opposed ends thereof;
the sheet having two cutouts on one of the opposed ends, each cutout being sized to accommodate a strut supporting the crash bar;
fasteners fitting in the holes and adapted to fasten the opposed ends of the sheet to the top and bottom sides of the crash bar respectively;
the sheet having a length sufficient to form a rounded fairing surface when the opposed ends of the sheet are attached to the top and bottom sides of the crash bar.
